(19) United States
(12) Patent Application Publication
(10) Pub. No.: US 2021/0237116 A1
(43) Pub. Date: Aug. 5, 2021

(54) ROBOTIC MARKING SYSTEM

(71) Applicant: Ross-Hime Designs, Inc., Vancouver, WA (US)

(72) Inventor: Mark E. Rosheim, Vancouver, WA (US)

(73) Assignee: Ross-Hime Designs, Inc., Vancouver, WA (US)

(21) Appl. No.: 17/149,883

(22) Filed: Jan. 15, 2021

Related U.S. Application Data
(60) Provisional application No. 62/969,640, filed on Feb. 3, 2020.

(51) Int. Cl. B05C 11/10; B05C 9/12; B25J 13/08; B25J 15/00; B25J 9/16

(52) U.S. Cl. CPC B05C 11/1018; B05C 11/1036; B25J 9/1664; B25J 13/086; B25J 15/0019; B05C 9/12

(57) ABSTRACT

Apparatus is provided for applying epoxy to a surface to form alphanumeric characters or other indicia. The apparatus may include a robotic system for facilitating controlled movement in mutually-perpendicular x, y and z directions, with a pen mounted to the robotic system so that the pen can be moved in the x, y and z directions, the pen having access to a supply of the epoxy.

### TECHNICAL FIELD

This application claims the benefit of U.S. Provisional Patent Application No. 62/969,640, filed on Feb. 3, 2020 and titled ROBOTIC MARKING SYSTEM. The entire disclosure of the application is hereby incorporated by reference as if fully stated herein.

This specification relates to robotics. More particularly, the present specification relates to robotic systems for placing markings on surfaces, particularly on surfaces of vehicles and aircraft.

### BACKGROUND

Repaired aircraft parts must be repainted prior to reinstallation, and then marked with lettering and/or insignia. One current robotic technology for repainting uses an industrial robot with a short carbon fiber tube end of arm tooling. Two paint guns are mounted to the tube. However, the application of markings using stencils continues to be conducted by hand as the spray head used to paint large areas are not capable of fine, high accuracy swaths. Significant material cost due to overspray keeps cost high. Currently, technology exists allowing for the automated painting and marking of aircraft parts using patented hardware and software for large-scale robotic inkjet printing on aircraft and other complex surfaces. Southwest Research Institute (Swirl) was awarded a patent (U.S. Pat. No. 9,527,275) for “High Accuracy Inkjet Printing,” in which ink is “printed” onto complex surfaces, such as aircraft parts, with high precision. Unfortunately, the ink utilized in this process is not equivalent to the MIL-PRF-85285 topcoat paint required for aircraft markings in accordance with T.O. 1-1-8, per AFMCI 21-117. Furthermore, inkjet printers are not capable of spraying the relatively more viscous MIL-PRF-85285 topcoat paint.

What is needed is a high accuracy system for robotic stenciling/painting of markings on work surfaces, in particular aircraft and vehicles.

### BRIEF DESCRIPTION OF THE DRAWINGS

The accompanying drawings, which are incorporated into and constitute a part of this specification, illustrate one or more embodiments of the inventive subject matter and, together with the detailed description, serve to explain the principles and implementations thereof. Like reference numbers and characters are used to designate identical, corresponding, or similar components in different figures. The figures associated with this disclosure typically are not drawn with dimensional accuracy to scale, i.e., such drawings have been drafted with a focus on clarity of viewing and understanding rather than dimensional accuracy.

FIG. 1 is a view of a representative embodiment of a robotic marking system.

FIG. 2 is a detailed view of the plotter attachment of the representative robotic marking system.

FIG. 3 shows a pen used with the representative robotic marking system.

FIG. 4 shows a flowchart of a representative method of operation for the representative robotic marking system.

### DETAILED DESCRIPTION

In describing the one or more representative embodiments of the inventive subject matter, use of directional terms such as “upper,” “lower,” “above,” “below”, “in front of,” “behind,” etc., unless otherwise stated, are intended to describe the positions and/or orientations of various components relative to one another as shown in the various Figures and are not intended to impose limitations on any position and/or orientation of any component relative to any reference point external to the Figures.

In the interest of clarity, not all of the routine features of representative embodiments of the inventive subject matter described herein are shown and described. It will, of course, be appreciated that in the development of any such actual implementation, numerous implementation-specific decisions must be made in order to achieve specific goals, such as compliance with application and business related constraints, and that these specific goals will vary from one implementation to another and from one developer to another. Those skilled in the art will recognize that numerous modifications and changes may be made to the representative embodiment(s) without departing from the scope of the claims. It will, of course, be understood that modifications of the representative embodiments will be apparent to those skilled in the art, some being apparent only after study, others being matters of routine mechanical, chemical and electronic design. No single feature, function or property of the representative embodiments is essential. In addition to the embodiments described, other embodiments of the inventive subject matter are possible, their specific designs depending upon the particular application. Any embodiment described as “comprising” includes the case of “consisting only of.” The scope of the inventive subject matter should not be limited by the particular embodiments herein described but should be defined only by the appended claims and equivalents thereof.

One aspect of the invention provides an apparatus for applying epoxy to a surface to form alphanumeric characters or other indicia. The apparatus may include a robotic system for facilitating controlled movement in mutually-perpendicular x, y and z directions, and a pen mounted to the robotic system so that the pen can be moved in the x, y and z directions, the pen having access to a supply of the epoxy. The apparatus may be capable of applying polyurethane topcoat epoxy paint, which may meet the requirements of MIL-PRF-85285.

The robotic system may control the movement of a graphic plotting head to which the pen is mounted, and may include a proximity sensor mounted to the graphic plotting head to determine distance between the pen and the surface to which epoxy is to be applied. The proximity sensor may also survey the surface to locate any surface anomalies or curvature so that the proximity sensor may be able to provide input that controls movement of the pen in the z direction toward and away from the surface.

Another aspect of the invention provides an apparatus for forming indicia on a surface. The apparatus may include a robotic system for facilitating highly controlled movement in mutually-perpendicular x, y and z directions with respect to the surface, a graphic plotting head mounted to the robotic system so the graphic plotting head can be moved in the x, y and z directions, a pen mounted to the graphic plotting head for applying liquid to the surface, the pen moving with the graphic plotting head in the x, y and z directions, and a proximity sensor mounted to the graphic plotting head to move with the graphic plotting head and the pen in the x, y and z directions to sense proximity of the pen to the surface, to sense the presence of any anomalies or curvature in the surface, and to control application of the liquid through the pen and to the surface.

The pen may be resiliently mounted by a spring to the graphic plotting head, and the pen may include at least one reservoir for storing and supplying epoxy to the pen. A plurality of reservoirs may be provided for storing and supplying a plurality of colors of epoxy to the pen, with at least one of the plurality of reservoirs storing and supplying cleaning fluid to the pen. A graphical user interface may be included to receive input from the proximity sensor and provide input to the pen.

The proximity sensor may be designed to store the anomalies and the curvature, and a controller may be provided to cause the graphic plotting head and the pen to move along the z axis to allow for the anomalies or the curvature in the surface.

Yet another aspect of the invention is a process for applying epoxy to a surface to form indicia. The process may involve selecting a robotic system for facilitating controlled movement of a graphic plotting head in mutually-perpendicular x, y and z directions with respect to the surface, mounting a pen to the graphic plotting head for applying the epoxy to the surface, mounting a proximity sensor to the graphic plotting head to move with the graphic plotting head and the pen in the x, y and z directions to sense proximity to the surface and to sense any surface anomalies. and then using the stored data to control application of the epoxy through the pen and to the surface to form the indicia.

The process may include a final step of purging the pen with cleaning solution following application of epoxy to the surface.

### Representative Embodiment—Structure

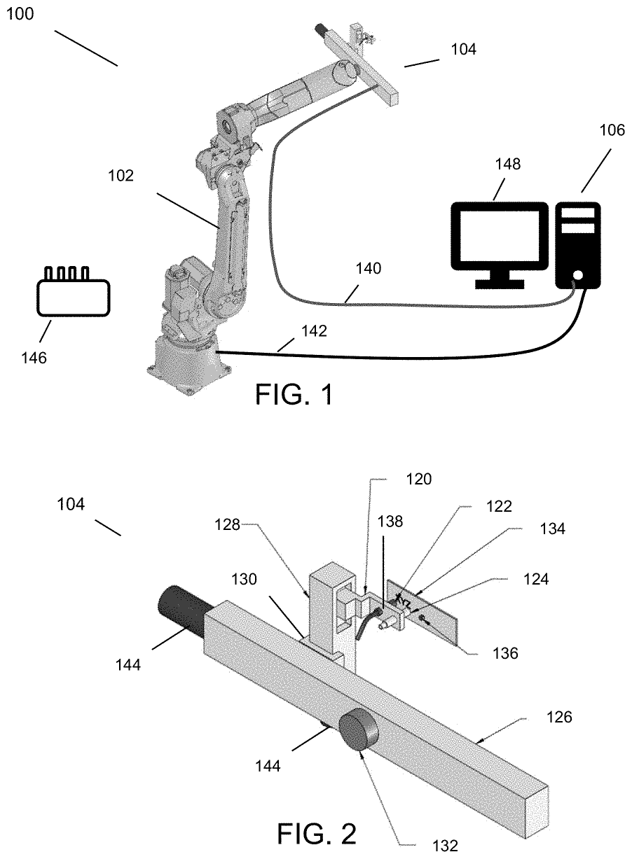

FIG. 1 shows a representative embodiment of a robotic marking system 100. The robotic marking system 100 comprises a plotter attachment 104 coupled to a robot arm 102, and a controller 106 communicatively coupled to the plotter attachment 104 and the robot arm 102 via electrical cables 140, 142. In some embodiments, the robot arm 102 has a separate controller. The robot arm 102, under the direction of the controller 106, is configured to place a front side of the plotter attachment 104 adjacent and parallel to a work surface 134 to be marked and the plotter attachment 104, under the direction of the controller 106, is configured to put markings on the work surface 134. The markings may include alpha-numeric characters and symbols such as arrows, boxes, frames, insignias, logos, signs, cautionary symbols.

FIG. 2 shows a detailed view of the plotter attachment 104. The plotter attachment 104 comprises an x-axis bar 126, a y-axis bar 128, a y-axis bracket 130 and a graphic plotting head 120. A mounting point 132 coupled to a back side of the x-axis bar 126, configured for detachably coupling with the robot arm 102. The y-axis bar 128 has a y-axis bracket 130 slidingly coupled to a front side of the x-axis bar 126, allowing the y-axis bracket 130, along with the y-axis bar 128, to move along the length of the x-axis bar 126 in an “X” direction defined by the long axis of the x-axis bar 126. The y-axis bar 128 is slidingly coupled with the y-axis bracket 130, allowing the y-axis bar 128 to move relative to the x-axis bar 126 in a “Y” direction orthogonal to the “X” direction and defined by the long axis of the y-axis bar 128. The graphic plotting head 120 is slidingly coupled with the y-axis bar 128 allowing the graphic plotting head 120 to move relative to the y-axis bar 128 in a “Z” direction orthogonal to the “X” and “Y” directions. In other embodiments, the graphic plotting head 120 is pivotally coupled with the y-axis bar 128, allowing a distal end of the graphic plotting head 120 to swing in an arc mostly in the “Z” direction. In the representative robotic marking system 100, the y-axis bracket 130, the y-axis bar 128 and the graphic plotting head 120 have electrical servo motors 144 configured to move them as described above.

In the representative robotic marking system 100, the components of the plotter attachment 104 are sized so as to give usable pen travel of 16.93″ (430 mm) in the “X” direction, 11.69″ (297 mm), in the “Y” direction and 0.7 inch (17 mm) in the “Z” direction. In other embodiments, the components of the plotter attachment 104 may be sized differently to give a different useable work envelope. In the representative robotic marking system 100, the x-axis bar 126 is machined from a solid billet of aluminum. This heavy, rigid structure provides improved straightness and stiffness. The y-axis bar 128 is a tube of extruded aluminum. However, in other embodiments, the components of the plotter attachment 104 may use different suitable materials and may be manufactured using different suitable techniques.

The graphic plotting head 120 comprises a pen holder 138, a pen 122 and a proximity sensor 124. The pen holder 138 is configured to detachably couple to the pen 122. In some embodiments, the pen holder 138 is spring loaded or has a small gas shock that allows the pen 122 to “float” over curved work surface 134 geometries without the controller 106 having to move the entire graphic plotting head 120. The proximity sensor 124 is positioned adjacent to the pen holder 138, typically offset in the “X” direction in the direction of drawing. In the representative robotic marking system 100, the direction of drawing is from left to right when facing towards the work surface 134, so the proximity sensor 124 is positioned to the right of the pen holder 138. A suitable proximity sensor 124 is the OMRON E2CY-SD non-ferrous metal proximity detector by Omnron Electronics LLC, Hoffman Estates, Ill., but other suitable proximity sensors may be used.

The graphic plotting head 120 is capable of application of multiple color polyurethane topcoat paint onto flat surfaces by use of multiple interchangeable pens 122. The pen holder 138 holds one pen 122 at a time, with the other pens 122 stored in a pen station 146 positioned near the robot arm 102. In the representative robotic marking system 100, the pen 122 in the pen holder 138 is changed manually by an operator to a different one of the pens 122 in the pen station 146. The operator may be prompted by the controller 106 when to change pens 122 and which pen 122 to change to. In other embodiments, the robotic marking system is configured to automatically change pens 122 as necessary, placing a first pen 122 it was previously holding in the pen holder 138 into the pen station 146 and taking up a second pen 122 out of the pen station 146.

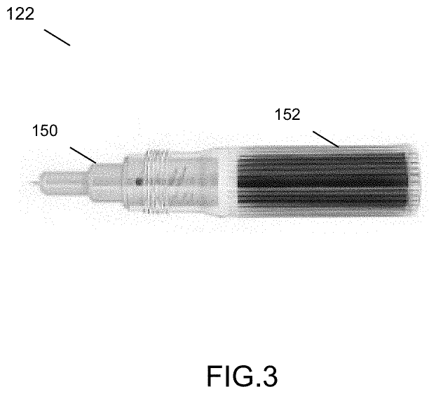

FIG. 3 shows a pen 122 used with the representative robotic marking system 100. Each of the pens 122 comprises a writing head 150 coupled to a reservoir 152 filled with ink (paint). In the representative robotic marking system 100, the reservoir 152 is detachably coupled to the writing head 150 and is re-fillable. The reservoir 152 can be detached from the writing head 150 and replaced with a different reservoir 152. This is performed automatically in the representative robotic marking system 100, but in other embodiments may be performed manually by an operator, typically at the prompting of the controller 106. In other embodiments, the reservoir 152 is more fixedly coupled to the writing head 150 and the entire pen 122 is disposable.

In yet other embodiments, a single writing head 150 is used with multiple reservoirs 152. The reservoir 152 attached to the writing head 150 of the pen 122 is changed from a first paint reservoir 152 to a second paint reservoir 152, the second typically with a different color paint than the first. In yet other embodiments, multiple writing heads 150 may be used, each with a different tip width (e.g. 0.18 mm, 0.25 mm, 0.35 mm, 0.50 mm, 0.70 mm, 1.00 mm) for use in making lines of different widths. Each may be coupled to one of several paint reservoir 152 of different colors.

The representative robotic marking system 100 is configured to purge (clean) the pen 122 at various times, typically after completion of use of the pen 122 or when switching paint reservoirs 152 on a pen 122. The first paint reservoir 152 is removed from the writing head 150 of the pen 122 and a cleaning reservoir 152 is coupled to the writing head 150. The cleaning reservoir 152 is filled with a cleaning solution, such as Mil-T-81772, Type 1 Reducer R91k20, Methyl Propyl. Cleaning fluid is then forced out the writing head 150 of the pen 122 or is allowed to flow out by placing the writing head 150 in close proximity to a blotting surface. The cleaning reservoir 152 is then removed, and the first paint reservoir 152 is replaced or a second paint reservoir 152 is coupled to the writing head 150, typically with a different color paint than the first. This purging (cleaning) of the pen 122 is performed automatically in the representative robotic marking system 100, but in other embodiments may be performed manually by an operator, typically at the prompting of the controller 106.

Each of the pens 122 is capable of application of a polyurethane topcoat paint with high viscosity (at least 16-20 seconds #2 Zahn). In some embodiments, the each of the pens 122 is capable of application of a polyurethane topcoat paint with a low VOC (at most 3.5 lbs/gallon). In some embodiments, each of the pens 122 is capable of application of a polyurethane topcoat paint with high solids (at least 57% by volume). In some embodiments, the each of the pens 122 is capable of application of a polyurethane topcoat paint meeting all requirements of MIL-PRF-85285.

The controller 106 is a computer with custom software. Off the shelf plotter software may be used to provide some of the functions. The custom software will implement a Graphical User Interface (GUI) to allow the user to set up the system and control operation via a user interface 148. The controller 106 is configured to implement a closed loop control system that receives input from the proximity sensor 124 and coordinate data from the plotter attachment 104. The controller 106 is configured to use the proximity sensor 124 to scan a target area for anomalies and store the locations of these anomalies, such as obstruction 136. The controller 106 is configured to determine proper and improper print areas within the target area, the improper areas due to the presence of anomalies. The controller 106 is configured to skip printing in improper print areas. When skipping anomalies, the controller 106 is configured to cause the pen 122 to move in the z-axis to avoid the anomalies. The controller 106 is configured to cause the pen 122 to move in the z-axis to accommodate any curvature of the work surface 134.

### Representative Embodiment—Operation

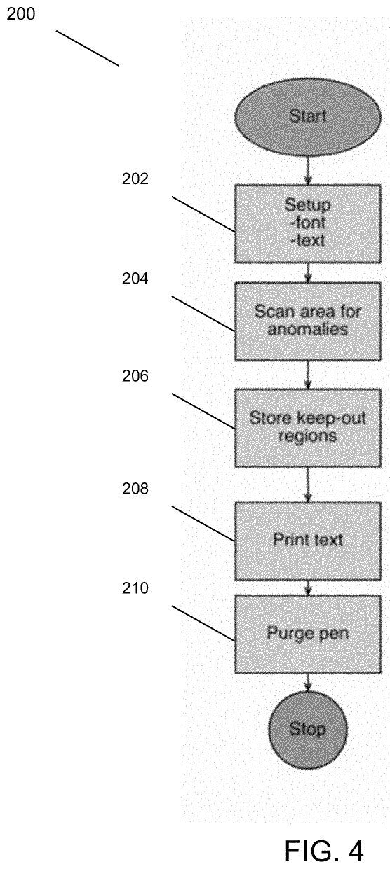

FIG. 4 shows a flowchart of a representative method of operation 200 for the representative robotic marking system 100. The representative method 200 starts with step 202, in which the representative robotic marking system 100 is setup for marking a work surface 134. In set up, the marking is selected, by user input or some other input source. The plotter attachment 104 is positioned over the target area of the work surface 134.

Proceeding then to step 204, the representative robotic marking system 100 scans the target area for anomalies (e.g. obstruction 136). The scanning is performed by the proximity sensor 124. Then in step 206, the controller 106 determines keep-out areas in the target area, based on anomalies that exceed pre-determined criteria.

The method 200 continues with step 208, which is printing. The controller 106 causes the plotter attachment 104 to move the y-axis bar 128, the y-axis bracket 130 and the graphic plotting head 120 as necessary so that the pen 122 is the proper distance from the work surface 134 to allow paint to flow onto the work surface 134 and to create the marking. The controller 106 causes the graphic plotting head 120 to move the pen 122 along the “Z” axis as necessary to avoid the keep-out areas. After printing is completed, the method 200 proceeds with step 201, purging of the pen 122, using the process described elsewhere herein. If the marking requires additional color paints to be applied to the target area of the work surface 134, then steps 208 and 210 can be repeated with a different color paint.

What is claimed is:

1. Apparatus for applying epoxy to a surface to form alphanumeric characters or other indicia, comprising:
a robotic system for facilitating controlled movement in mutually-perpendicular x, y and z directions; and
a pen mounted to the robotic system so that the pen can be moved in the x, y and z directions, the pen having access to a supply of the epoxy.

2. The apparatus of claim 1 wherein the apparatus is capable of applying polyurethane topcoat epoxy paint.

3. The apparatus of claim 2 wherein the epoxy paint to be applied meets requirements of MIL-PRF-85285.

4. The apparatus of claim 1 wherein the robotic system controls the movement of a graphic plotting head mounted thereto, the pen also being mounted to the graphic plotting head, further comprising a proximity sensor mounted to the graphic plotting head to determine distance between the pen and the surface to which epoxy is to be applied.

5. The apparatus of claim 4 wherein the proximity sensor also surveys the surface to locate any surface anomalies or curvature.

6. The apparatus of claim 5 the proximity sensor provides input that controls movement of the pen in the z direction toward and away from the surface.

7. Apparatus for forming indicia on a surface, comprising:
a robotic system for facilitating highly controlled movement in mutually-perpendicular x, y and z directions with respect to the surface;
a graphic plotting head mounted to the robotic system so the graphic plotting head can be moved in the x, y and z directions;
a pen mounted to the graphic plotting head for applying liquid to the surface, the pen moving with the graphic plotting head in the x, y and z directions; and
a proximity sensor mounted to the graphic plotting head to move with the graphic plotting head and the pen in the x, y and z directions to sense proximity of the pen to the surface, to sense the presence of any anomalies or curvature in the surface, and to control application of the liquid through the pen and to the surface.

8. The apparatus of claim 7, wherein the pen is resiliently mounted by a spring to the graphic plotting head.

9. The apparatus of claim 7 wherein the pen includes at least one reservoir for storing and supplying epoxy to the pen.

10. The apparatus of claim 9, further comprising a plurality of reservoirs storing and supplying a plurality of colors of epoxy to the pen.

11. The apparatus of claim 10 wherein at least one of the plurality of reservoirs stores and supplies cleaning fluid to the pen.

12. The apparatus of claim 7, further comprising a graphical user interface to receive input from the proximity sensor and provide input to the pen.

13. The apparatus of claim 7 wherein the proximity sensor stores the anomalies and the curvature.

14. The apparatus of claim 13, further comprising a controller to cause the graphic plotting head and the pen to move along the z axis to allow for the anomalies or the curvature in the surface.

15. A process for applying epoxy to a surface to form indicia, comprising:
selecting a robotic system for facilitating controlled movement of a graphic plotting head in mutually-perpendicular x, y and z directions with respect to the surface;
mounting a pen to the graphic plotting head for applying the epoxy to the surface;
mounting a proximity sensor to the graphic plotting head to move with the graphic plotting head and the pen in the x, y and z directions to sense proximity to the surface and to sense any surface anomalies;
storing data collected from the proximity sensor scan; and
using the stored data to control application of the epoxy through the pen and to the surface to form the indicia.

16. The process of claim 15, further comprising purging the pen with cleaning solution following application of epoxy to the surface.
